(19) United States
(12) Patent Application Publication
(10) Pub. No.: US 2012/0306366 A1
(43) Pub. Date: Dec. 6, 2012

(54) BULB-TYPE LAMP AND LUMINAIRE USING BULB-TYPE LAMP

(75) Inventors: Makoto SAKAI, Yokosuka-shi (JP); Toshitake KITAGAWA, Yokosuka-shi (JP); Takeshi HISAYASU, Yokosuka-shi (JP)

(73) Assignee: Toshiba Lighting & Technology Corporation, Kanagawa (JP)

(21) Appl. No.: 13/421,814

(22) Filed: Mar. 15, 2012

(30) Foreign Application Priority Data
May 31, 2011 (JP) 2011-122345

(51) Int. Cl. H01J 7/44

(52) U.S. Cl. 315/51

(57) ABSTRACT

According to an embodiment, an LED lamp includes a thermal radiation unit on which an LED module with a light source mounted thereon is mounted and which has a function of radiating heat generated from the LED module, and an insulating case which is integrally molded inside the thermal radiation unit in order to electrically insulate a drive circuit of the LED module provided inside and the thermal radiation unit from each other.

### CROSS-REFERENCE TO RELATED APPLICATIONS

This application is based upon and claims the benefit of priority from the Japanese Patent Application No. 2011-122345, filed on May 31, 2011; the entire contents of which are incorporated herein by reference.

### FIELD

An embodiment described herein relates generally to a bulb-type lamp which emits radiant light from an LED (light emitting diode) to outside, and a luminaire using the bulb-type lamp.

### BACKGROUND

Recently, an LED bulb which can realize a longer life and power saving compared with a typical incandescent lamp is commercially available.

An LED has a lower light output and a shorter life as temperature rises. Therefore, a lamp using an LED as a light source is configured so as to improve thermal radiation performance of the LED in order to restrain temperature rise in the LED.

An LED bulb of this type includes, for example, an LED module with plural surface-mounted LEDs, a thermal radiation unit which is a base body having the LED module thereon and has a function of radiating heat generated from the LEDs via plural thermal radiation fins, an outer peripheral surface and the like, a globe which is mounted on the thermal radiation unit and covers the LED module to emit radiant light from the LEDs to outside, a cap provided opposite the globe, and an insulating case provided inside the thermal radiation unit and adapted for electrically insulating a drive circuit of the LED module and the thermal radiation unit from each other.

In an LED bulb according to the related art, separate members are used as a thermal radiation unit which is a base body made of a heat-conductive member such as a metal, and as an insulating case made of an insulating member such as a resin. Therefore, a process of manufacturing the LED bulb needs to include a process of fixing the insulating case to the thermal radiation unit. This process is a factor in the reduction in productivity of the LED bulb.

To improve productivity of the LED bulb, easing dimensional tolerance in the process of assembling the two members together is conceivable. However, if this process is implemented, sufficiently tight contact between the thermal radiation unit and the insulating case cannot be secured. Therefore, heat generated by the drive circuit cannot be transmitted sufficiently from the insulating case to the thermal radiation unit, causing an inconvenience of lowered thermal radiation performance.

### BRIEF DESCRIPTION OF THE DRAWINGS

FIG. 1 is a sectional view of a bulb-type lamp according to an embodiment.

FIG. 2 is a front view of the bulb-type lamp.

FIG. 3 is a perspective view showing the configuration of a thermal radiation unit in which an insulating case of FIG. 1 is integrally molded.

FIG. 4 is a top view showing the thermal radiation unit in which the insulating case is integrally molded.

FIG. 5 shows the configuration of a luminaire having an LED bulb.

### DETAILED DESCRIPTION

A bulb-type lamp according to this embodiment includes a thermal radiation unit on which an LED module with a light source mounted thereon is mounted and which has a function of radiating heat generated from the LED module, and an insulating case which electrically insulates a drive circuit of the LED module provided inside and the thermal radiation unit from each other and which is integrally molded in the thermal radiation unit.

In this embodiment, some of the terms used herein have the following definitions and technical meanings unless stated otherwise.

The LED module is equipped with a light source and uses, for example, a flat plate-like light source unit having a light-emitting surface on which plural LEDs as a light source are surface-mounted. However, organic EL and the like may also be used other than LEDs. The LED module is arranged in such a manner that the light-emitting surface is opposite the mounting surface, and the mounting surface on the back side of the light-emitting surface is arranged on the thermal radiation unit.

The thermal radiation unit forms a base body and has the function of radiating heat generated from the LED module mounted thereon. The thermal radiation unit uses, for example, a highly heat-conductive metal. The highly heat-conductive metal may be, for example, a die cast member using aluminum or the like. Of course, the highly heat-conductive metal is not limited to this die cast member of aluminum or the like, and other metals may also be used.

The shape of the thermal radiation unit is not particularly limited as long the shape enables effective radiation of heat. For example, plural thermal radiation fins may be provided on a lateral portion, in a radial form extending outward from the center of the thermal radiation unit.

The insulating case is made of an insulative resin member such as a resin and electrically insulates the drive circuit of the LED module provided inside and the thermal radiation unit from each other. This insulating case is integrally molded in the thermal radiation unit. The technique for integrally molding in the thermal radiation unit may be, for example, injection molding using an insulating member, but not limited to this technique. As the resin member, a resin member with a high heat conductivity may be preferably used.

The thermal radiation unit as the base body has a communication port through which an opening provided on a top surface and an opening provided on a bottom surface communicate with each other. The insulating case is arranged inside the communication port so as to fill the communication port and is provided to cover a portion of the bottom surface of the thermal radiation unit. However, the arrangement of these parts is not limited to this configuration.

An irregular shape is formed on an inner peripheral surface of the communication port. However, the irregular shape may be formed only in a portion of the inner circumferential surface. As the irregular shape is formed on the inner circumferential surface of the communication port, tight contact between the thermal radiation unit and the insulating case that is integrally molded therein can be improved and fixing of the insulating case can be reinforced.

Moreover, though the insulating case is arranged at a position below the mounting surface for the LED module, of the thermal radiation unit, the arrangement is not limited to this example.

With the above configuration in which the thermal radiation unit and the insulating case are integrally molded to improve tight contact, the manufacturing process for the bulb-type lamp according to this embodiment can be simplified and productivity and thermal radiation performance can be improved.

A luminaire according to an embodiment includes the bulb-type lamp, and a luminaire main body having a socket in which the bulb-type lamp is installed. Therefore, a luminaire having similar advantages to the bulb-type lamp of the embodiment can be provided.

### Embodiment

Hereinafter, this embodiment will be described in detail with reference to the drawings.

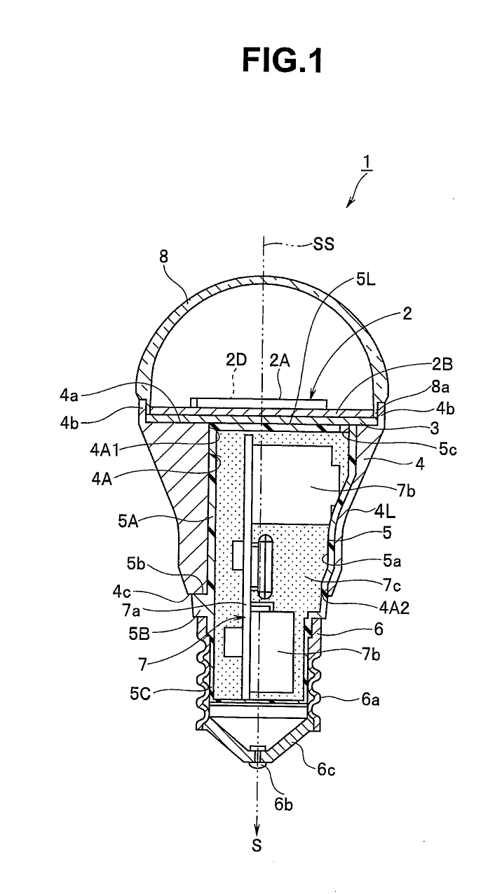

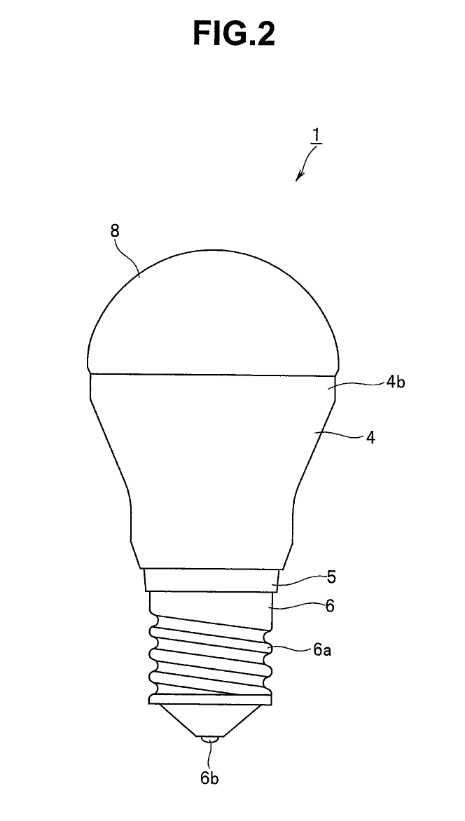

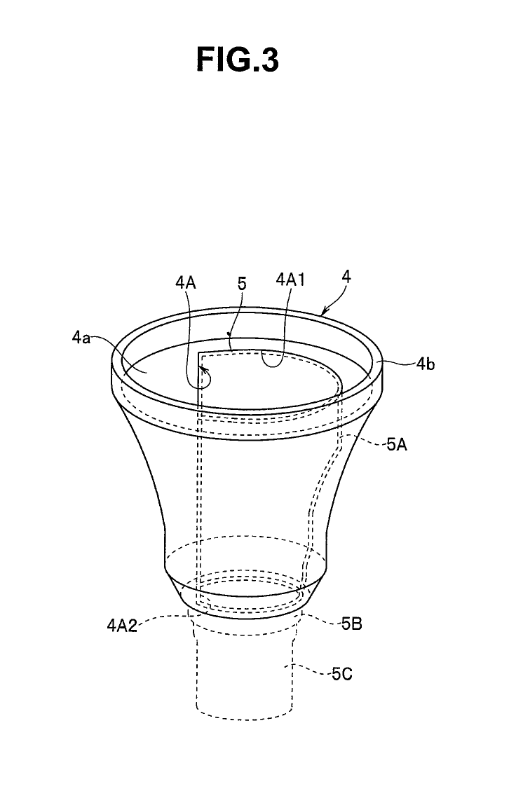

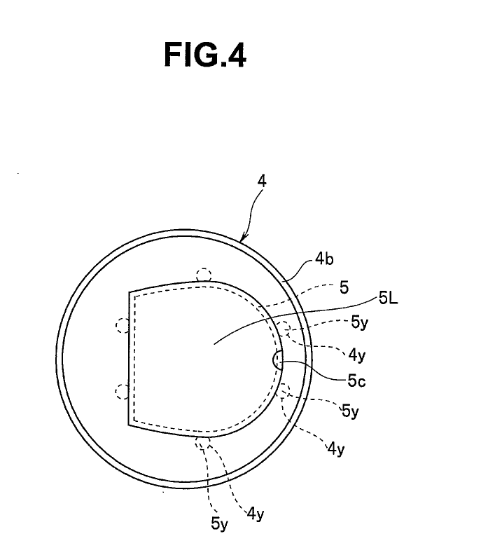

FIG. 1 to FIG. 4 relate to the bulb-type lamp of the embodiment. FIG. 1 is a sectional view showing the bulb-type lamp according to the embodiment. FIG. 2 is a front view of the bulb-type lamp of FIG. 1. FIG. 3 is a perspective view showing the configuration of a thermal radiation unit in which an insulating case of FIG. 1 is integrally molded. FIG. 4 is a top view of the thermal radiation unit in which the insulating case of FIG. 1 is integrally molded.

As shown in FIG. 1 and FIG. 2, an LED lamp 1 that is a bulb-type lamp according to this embodiment includes an LED module 2 that is a light emitting module having a light-emitting surface 2A, a thermal radiation plate 3, a thermal radiation unit 4 forming a base body, an insulating case 5, a cap 6, a drive circuit 7, and a globe 8.

The LED module 2 is a flat plate-like light source unit having the light-emitting surface 2A on which plural LEDs 2D (not shown) as a light source are surface-mounted. In the LED module 2, the plural LEDs 2D are surface-mounted on one surface of a flat cuboidal substrate 2B, thus forming the light-emitting surface 2A.

Although not shown, a printed wiring of the LED module 2 is connected to a connector, not shown, on the substrate 2B. A lead wire from the drive circuit 7 is connected to this connector. The LED module 2 is arranged so that the light-emitting surface 2A faces outward, that is, opposite the mounting surface, and the mounting surface of the substrate 2B on the back side of the light-emitting surface 2A is installed in tight contact with the thermal radiation plate 3.

The thermal radiation plate 3 is formed in the shape of a flat plate, and a surface thereof opposite the mounting surface of the substrate 2B is installed in tight contact with a mounting surface 4a of the thermal radiation unit 4 and a top surface 5L of the insulating case 5. This thermal radiation plate 3 transmits heat generated from the LED module 2 and transmitted via the substrate 2B, toward the thermal radiation unit 4. The thermal radiation plate 3 is made of, for example, a heat-conductive member.

The thermal radiation unit 4 forms a base body. The substrate 2B of the LED module 2 is installed via the thermal radiation plate 3 on the mounting surface 4a. The thermal radiation unit 4 has a function of radiating heat generated from the LED module 2 and transmitted via the thermal radiation plate 3, and is made of a heat-conductive member. For example, a highly heat-conductive metal is used. The highly heat-conductive metal may be, for example, a die cast member using aluminum or like. Of course, the highly heat-conductive metal is not limited to this die cast member of aluminum or the like, and other metals may also be used.

The thermal radiation unit 4 is circular in a cross section orthogonal to a center axis SS and has a shape including a portion with a sectional diameter gradually decreasing from the mounting surface 4a for the LED module 2 toward a bottom end surface, followed by a portion with the same diameter, and a tapered portion with a sectional diameter gradually decreasing from the same-diameter portion toward a bottom end surface 4c.

On an outer periphery of the mounting surface 4a of the thermal radiation unit 4, a flange portion 4b that is a protruding portion protruding in a direction opposite to a mounting direction S indicated by an arrow in FIG. 1 is provided. The flange portion 4b forms a fitting portion to fit and install the globe 8.

The thermal radiation unit 4 has a communication port 4A through which an opening 4A1 provided on the mounting surface 4a and an opening 4A2 provided on the bottom end surface communicate with each other. Inside the communication port 4A, the insulating case 5 is arranged so as to fill the communication port 4A. The insulating case 5 is provided also to cover a portion of the bottom end surface 4c of the thermal radiation unit 4.

An irregular shape is formed in a portion of an inner peripheral surface of the communication port 4A. Specifically, the inner peripheral surface of the communication port 4A has a surface parallel to the center axis SS, on a cross section orthogonal to the center axis SS, and an irregular surface extended from this parallel surface and formed in an irregular shape such that the distance from the center axis SS varies, as shown in FIG. 1 and FIG. 2.

An outer peripheral surface 4L of the thermal radiation unit 4 functions as a thermal radiation surface. The shape of the outer peripheral surface 4L of the thermal radiation unit 4 is not particularly limited as long the shape enables effective radiation of heat. For example, plural thermal radiation fins may be provided on a lateral portion, in a radial form extending outward from the center of the thermal radiation unit 4.

The insulating case 5 is a case using an insulative resin member with a high heat conductivity, such as a resin. As the resin member, for example, a high heat-conductive resin with a heat conductivity of 1.0 W/m×K or higher is desirable.

The insulating case 5 has a top surface 5L flush with the mounting surface 4a of the thermal radiation unit 4, a lateral portion 5A extended from the top surface 5L and formed to follow the shape of the inner peripheral surface of the thermal radiation unit 4, a fixing portion 5B extended from the lateral portion 5A and formed to cover a portion of the bottom end surface 4c of the thermal radiation unit 4, and a mounting portion 5C which is formed below the fixing portion 5B (in the mounting direction S indicated by the arrow in FIG. 1) and on which the cap 6 is mounted.

That is, the insulating case 5 is arranged at a position below the mounting surface 4a so that the top surface 5L of the insulating case 5 can be flush with the mounting surface 4a for the LED module 2, of the thermal radiation unit 4.

The fixing portion 5B of the insulating case 5 is formed in such a manner that the diameter thereof becomes larger than the opening 4A2 of the thermal radiation unit 4, in a cross section orthogonal to the center axis SS, and has a fixing surface 5b that comes in tight contact with the bottom end surface 4c of the thermal radiation unit 4 and thus becomes fixed.

Inside the insulating case 5, the drive circuit 7 of the LED module 2 is provided. The insulating case 5 electrically insulates the drive circuit 7 provided inside and the thermal radiation unit 4 from each other.

The cap 6, connected to the drive circuit 7 and mounted on the mounting portion 5C of the insulating case 5, includes a cylindrical screw portion 6a made of an iron sheet with screw threads, and an electrically conductive terminal portion 6b provided at a bottom end apex of the screw portion 6a via an electrical insulating portion 6c. An opening of the screw portion 6a is fitted and fixed to the mounting portion 5C of the insulating case 5 from outside.

The drive circuit 7 has a flat plate-like circuit board 7a on which circuit components constituting a light circuit of each LED 2D are mounted. The light circuit is configured to convert an AC voltage of 100 V to a DC voltage of 24 V and supply a constant direct current to each LED 2D. The circuit board 7a is configured, for example, in a longitudinally extended shape, and a circuit pattern is formed on one or both sides thereof. Plural small electronic components 7b for forming the lighting circuit, such as a lead component of a small electrolytic capacitor and a chip component of a transistor and the like, are mounted on a mounting surface of the circuit board 7a.

The drive circuit 7 of this configuration is housed longitudinally in the insulating case 5 so that the circuit board 7a becomes parallel to the center axis SS. After that, the inside of the insulating case 5 is filled with a filler 7c having good heat conductivity and good electric insulating performance, such as a silicone resin or epoxy resin, and the circuit board 7a and the electronic components 7b are buried and fixed. Thus, since heat generated from each electronic component 7b is transmitted to the filler 7c, temperature rise in the drive circuit 7 can be restrained and the life of the drive circuit 7 can be maintained.

The globe 8 covers the LED module 2 and emits radiant light from the light-emitting surface 2A of the LED module 2 to outside. The portion covering the LED module 2 is made light-transmissive.

As the light-transmissive member, for example, a resin member that is light-transmissive and diffusive is used. This resin member is made of, for example, a thermoplastic material such as polycarbonate.

The globe 8 is provided to cover and face the light-emitting surface 2A of the LED module 2, then a fitting portion 8a integrally formed at an opening end portion on one end side is fitted on the inner surface of the flange portion 4b of the thermal radiation unit 4, and the globe 8 is installed using a highly heat-conductive adhesive such as a silicone resin or epoxy resin. Thus, the globe 8 is supported in and fixed to an opening inside the flange portion 4b of the thermal radiation unit 4.

The LED lamp 1 of this embodiment is formed by having the insulating case 5 integrally molded in the thermal radiation unit 4.

A process of manufacturing the LED lamp 1 including such an integral molding process will be described with reference to FIG. 1 to FIG. 3.

The operator integrally molds in advance the insulating case 5 of the shape shown in FIG. 1 and indicated by the dotted line in FIG. 3, for example, by injection molding in the thermal radiation unit 4 that is molded as shown in FIG. 3. In this case, the top surface 5L of the insulating case 5 is preferably a separate member.

By this integral molding process, the thermal radiation unit 4 and the insulating case 5 integrally molded therein can be formed as a single molded component as indicated by the dotted line in FIG. 3, instead of separate components.

Next, the operator inserts the circuit board 7a of the drive circuit 7 longitudinally into the insulating case 5 integrally molded in the thermal radiation unit 4, and supports and houses the circuit board 7a at a predetermined position. Then, the top surface 5L, which is a separate member, is fixed, for example, with adhesive or the like so as to close the opening of the insulating case 5. After that, the inside of the insulating case 5 is filled with the filler 7c from an injection hole, not shown, on the top surface 5L.

In this case, though not shown, a leading end of a lead wire for power supply, not shown, on the circuit board 7a is led out from a through-hole 5c (see FIG. 4) provided on the top surface 5L of the insulating case 5, and a leading end of an input line is led out from the bottom side of the mounting portion 5C of the insulating case 5 in advance. Next, the lead wire led out from the through-hole 5c is connected to the connector, not shown, on the substrate 2B where the LEDs 2D are mounted.

Next, the operator fixes the thermal radiation plate 3 onto the mounting surface 4a of the thermal radiation unit 4 and the top surface 5L of the insulating case 5 and also fixes the substrate 2B of the LED module 2 to the top surface of the thermal radiation plate 3. A fixing measure such as a screw is used to fix the substrate 2B. At this point, since the thermal radiation plate 3 uses a heat-conductive member, the flat surfaces of the back side of the substrate 2B on one hand and the mounting surface 4a of the thermal radiation unit 4 and the top surface 5L of the insulating case 5 on the other are fixed in tight contact.

Next, the operator connects the input line led out from the bottom side of the mounting portion 5C of the insulating case 5 to the screw portion 6a and the terminal portion 6b of the cap 6. In the connected state, an opening portion of the screw portion 6a is fitted into the mounting portion 5C of the insulating case 5 and fixed thereto with an adhesive.

Finally, the operator places the globe 8 in the opening inside the flange portion 4b of the thermal radiation unit 4 as a base body so as to cover the LED module 2 on the substrate 2B, then fits the fitting portion 8a of the globe 8 with the inner surface of the flange portion 4b of the thermal radiation unit 4, and fixes the fitting portion 8a thereto with an adhesive.

The LED lamp 1 as shown in FIG. 2 can thus be assembled.

In this manner, in this embodiment, the thermal radiation unit 4 and the insulating case 5 are formed as a single molded component by integral molding. Therefore, if a molded component including the insulating case 5 formed in advance on the thermal radiation unit 4 is prepared, the process of fixing the insulating case 5 to the thermal radiation unit 4 as carried out in the related art can be omitted at the time of assembling the LED lamp 1 and productivity can be improved.

Also, for example, in injection molding of the insulating case 5 on the thermal radiation unit 4, the insulating case 5 is fixed to the inner peripheral surface of the communication port 4A of the thermal radiation unit 4. Particularly at the site where the inner peripheral surface is formed as an irregular surface, the surface is greater than a flat surface. Therefore, the degree of tight contact with the insulating case 5 is high and the insulating case 5 can be fixed firmly.

The inner peripheral surface of the communication port 4A may also be made irregular by providing a step portion or a groove portion of V-shape or the like. Alternatively, for example, sand blast treatment may be performed on the entire inner peripheral surface to form an irregular surface.

Moreover, in addition to the irregular surface, plural groove portions (or recessed portions) 4y of a substantially spherical shape may be provided on the flat surface and the irregular surface, too, of the inner peripheral surface of the communication port 4A of the thermal radiation unit 4, and the insulating case 5 may be injection-molded, thus forming anchor portions 5y respectively in the plural groove portions 4y, for example, as shown in FIG. 4. As the plural anchor portions 5y are formed, the tight contact between the thermal radiation unit 4 and the insulating case 5 is improved and the fixing state of the insulating case 5 to the thermal radiation unit 4 can be reinforced.

As the tight contact between the thermal radiation unit 4 and the insulating case 5 is improved, heat generated from the drive circuit 7 in the insulating case 5 can be transmitted effectively toward the thermal radiation unit 4 and thus radiated. Since the cap 6 is mounted on the mounting portion 5C of the insulating case 5, the heat generated from the drive circuit 7 in the insulating case 5 can also be transmitted effectively toward the cap 6 and thus radiated. Thus, temperature rise in the drive circuit 7 can be restrained and the life of the drive circuit 7 can be maintained.

The fixing portion 5B extended from the lateral portion 5A of the insulating case 5 is provided to cover a portion of the bottom end surface 4c of the thermal radiation unit 4. Thus, the tight contact of the insulating case 5 with the thermal radiation unit can be reinforced.

Moreover, the insulating case 5 is arranged at a position below the mounting surface 4a so that the top surface 5L of the insulating case 5 becomes flush with the mounting surface 4a for the LED module 2, of the thermal radiation unit 4. With this configuration, the tight contact between the thermal radiation plate 3 and the substrate 2B of the LED module 2 and between the thermal radiation unit 4 and the insulating case 5 can be improved and the fixing strength can thus be increased. Also, the heat generated from the LED module 2 can be transmitted effectively to the thermal radiation unit 4 and thus radiated. Moreover, assembling the thermal radiation plate 3 and the LED module 2 onto the thermal radiation unit 4 with the insulating case 5 integrally molded therein can be made easier.

Thus, according to this embodiment, as the thermal radiation unit 4 and the insulating case 5 are integrally molded and the tight contact between these members is improved, a bulb-type lamp, that the manufacturing processing thereof can be simplified and productivity and thermal radiation performance thereof can be improved, can be realized. Of course, it is possible to reduce the manufacturing cost of the bulb-type lamp.

If luminaire main body having a socket with such an LED lamp installed therein is configured, a luminaire that has the same advantages as described above can be realized.

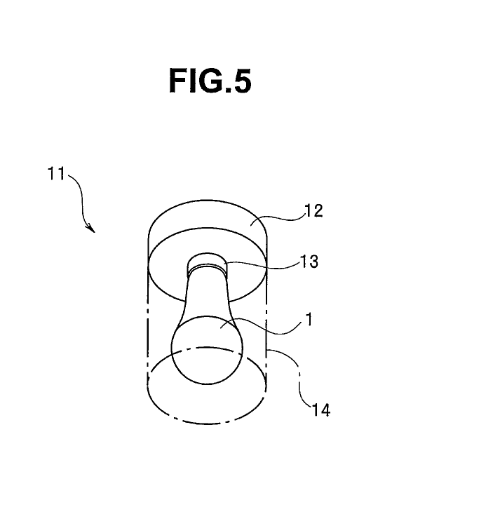

FIG. 5 shows the configuration of a luminaire having the above LED lamp 1. As shown in FIG. 5, a luminaire 11 is formed by having the LED lamp 1 installed in a socket 13 provided on a pedestal 12 of the luminaire 11. A cover 14 is mounted on the pedestal 12.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A bulb-type lamp comprising:
an LED module with a light source mounted thereon;
a thermal radiation unit on which the LED module is mounted, for radiating heat generated from the LED module; and
an insulating case which is integrally molded in the thermal radiation unit and electrically insulates a drive circuit of the LED module provided therein from the thermal radiation unit.

2. The lamp according to claim 1, wherein the thermal radiation unit is made of a heat-conductive member, and the insulating case is integrally molded in the thermal radiation unit by injection molding using an insulating member.

3. The lamp according to claim 1, wherein the thermal radiation unit is made of a metal.

4. The lamp according to claim 1, wherein the thermal radiation unit comprises a port having an opening provided on a top surface and an opening provided on a bottom surface, and the insulating case is arranged inside the port so as to fill the port.

5. The lamp according to claim 4, wherein an irregular shape is formed on an inner peripheral surface of the port.

6. The lamp according to claim 5, wherein the thermal radiation unit is made of a heat-conductive member, and the insulating case is integrally molded on the inner peripheral surface of the port of the thermal radiation unit by injection molding using an insulating member.

7. The lamp according to claim 6, wherein a recessed portion is provided on the inner peripheral surface of the port of the thermal radiation unit.

8. The lamp according to claim 5, wherein the irregular shape is formed by an irregular surface of the inner peripheral surface.

9. The lamp according to claim 8, wherein the irregular surface is formed by sand blast treatment on the inner peripheral surface.

10. The lamp according to claim 1, wherein the insulating case is arranged at a position below a mounting surface for the LED module, of the thermal radiation unit.

11. The lamp according to claim 1, wherein the insulating case comprises a top surface flush with a mounting surface of the thermal radiation unit, a lateral portion extended from the top surface and formed to follow a shape of an inner peripheral surface of the thermal radiation unit, a fixing portion extended from the lateral portion and formed to cover a portion of a bottom end surface of the thermal radiation unit, and a mounting portion which is formed below the fixing portion and on which a cap is mounted.

12. The lamp according to claim 1, comprising a globe provided to cover a light-emitting surface of the LED module.

13. A luminaire comprising:
a bulb-type lamp; and
a luminaire main body comprising a socket in which the bulb-type lamp installed,
wherein the bulb-type lamp comprises:
an LED module with a light source mounted thereon; a thermal radiation unit on which the LED module is mounted, for radiating heat generated from the LED module; and
an insulating case which is integrally molded in the thermal radiation unit and electrically insulates a drive circuit of the LED module provided therein from the thermal radiation unit.

14. The luminaire according to claim 13, wherein the thermal radiation unit is made of a heat-conductive member, and the insulating case is integrally molded in the thermal radiation unit by inj ection molding using an insulating member.

15. A bulb-type lamp comprising:
an LED module having a substrate with a light source mounted on one side of the substrate;
a thermal radiation unit thermally coupled to the substrate and extending in a direction that is opposite the one side of the substrate;
an insulating case integrally molded in an interior portion of the thermal radiation unit; and
a drive circuit of the LED module arranged inside the insulating case.

16. The bulb-type lamp according to claim 15, wherein the insulating case has protruding sections that each extend into a corresponding recessed portion in the interior portion of the thermal radiation unit.

17. The bulb-type lamp according to claim 16, wherein the protruding sections and the corresponding recessed portions have a spherical shape.

18. The bulb-type lamp according to claim 15, further comprising:
a globe that covers the light source; and
a cap at a bottom end of the thermal radiation unit that is opposite a top end to which the substrate is mounted.

19. The bulb-type lamp according to claim 18, further comprising:
a thermal radiation plate by which the substrate is thermally coupled to the thermal radiation unit.
